(19) United States
(12) Patent Application Publication
(10) Pub. No.: US 2013/0045643 A1
(43) Pub. Date: Feb. 21, 2013

(54) MODULAR JACK CIRCUIT AND MODULAR JACK USING THE SAME

(71) Applicants: Jun-Hua HU, Kun Shan (CN); Yong-Chun XU, Kunshan (CN)

(72) Inventors: Jun-Hua HU, Kun Shan (CN); Yong-Chun XU, Kunshan (CN)

(73) Assignee: HON HAI PRECISION INDUSTRY CO., LTD., New Taipei (TW)

(21) Appl. No.: 13/588,252

(22) Filed: Aug. 17, 2012

(30) Foreign Application Priority Data
Aug. 19, 2011 (CN) 201110237894.2

(51) Int. Cl. H01R 24/28; H02B 1/24

(52) U.S. Cl. 439/676; 307/115

(57) ABSTRACT

A modular jack circuit (100) is diposed between a cable side (10) for connecting with a mating plug and a physical side (20) for connecting with a mother board. The moular jack circuit comprises a first transmitting channel and a second transmitting channel. The moular jack circuit includes a number of filtering electronic elements (2, 3) and a number of relays (1, 4) disposed between the filtering electronic elements and the cable side. The first and second transmitting channels share the filtering electronic elements. The relays control the filtering electronic elements to transmit signals for the first and second channels at different times.

### BACKGROUND OF THE INVENTION

1. Field of the Invention

The present invention relates to a modular jack circuit and a modular jack using the same.

2. Description of Prior Arts

U.S. Publication No. 2011/0304411 discloses a modular jack circuit including a plurality of filtering electronic elements disposed between a cable side and a physical side. The filtering electronic elements include four transformers and four common mode chokes connected, respectively, with the transformers. The modular jack circuit is used for transmitting signals for one port of a modular jack. To transmit signals for two ports, the modular jack needs eight transformers and eight common mode chokes resulting in an increased number of components and manufacturing cost.

U.S. Pat. No. 6,816,499, issued to Povse et al. on Nov. 9, 2004, discloses a switch including, among others, a high speed port fitted with two connectors. One of the two connectors could be a DB-9 connector with its output connected to a 150 Ohm transmission line and the other could be an RJ-45 connector with its output connected to a 100 Ohm transmission line. The DB-9 connector includes two “read” terminals connected to two windings of a first transformer and two “transmit” terminals connected to two windings of a second transformer. The RJ-45 connector includes two read pins connected through a coil to another two windings of the first transformer and two transmit pins connected through another coil to another two windings of the second transformer. The physical side of each of the first and second transformers has two windings and port connections coupled through a switching relay to terminals on a media access control circuit.

### SUMMARY OF THE INVENTION

An object of the present invention is to provide a modular jack having less components and low manufacturing cost.

To achieve the above object, a modular jack circuit is disposed between a cable side for connecting with a mating plug and a physical side for connecting with a mother board. The modular jack circuit compresses a first transmitting channel and a second transmitting channel. The modular jack circuit comprises a plurality of filtering electronic elements and a plurality of relays disposed between the filtering electronic elements and the cable side. The first and second transmitting channels share the filtering electronic elements, the relays controll the first and second transmitting channels to transmit signals at different times. Through the relays, two ports of a modular jack could share four transformers and four common mode chokes. Thus, the modular jack has less components and low manufacturing cost.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a modular jack circuit diagram in accordance with the present invention;

FIG. 2 is a perspective view of a modular jack using the modular jack circuit as shown in FIG. 1;

FIG. 3 is an exploded view of the modular jack as shown in FIG. 2;

FIG. 4 is another exploded view of the modular jack as shown in FIG. 2;

FIG. 5 is an exploded view of a contact module as shown in FIG. 4; and

FIG. 6 is another exploded view of the contact module as shown in FIG. 4.

### DETAILED DESCRIPTION OF THE PREFERRED EMBODIMENT

Reference will now be made to the drawing figures to describe the present invention in detail.

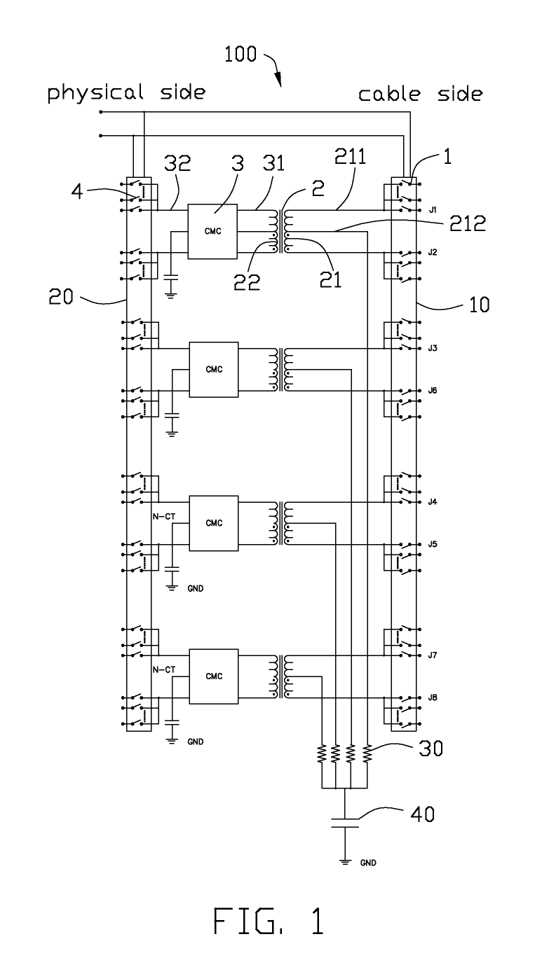

FIG. 1 shows a modular jack circuit 100 according to the invention. The modular jack circuit 100 could transmit signals from two ports, i.e., supporting two modular jack connectors. The modular jack circuit 100 has four transmitting passageways, a cable side 10 for connecting with a mating plug, a physical side 20 for connecting with a mother board, and a plurality of relays. Each of the transmitting passageways transmits signals from two ports and shares one transformer 2 and one common mode choke 3. The relays include a first relay 1 connected with the cable side 10 and a second relay 4 connected with the physical side 20. The transformer 2 has a primary coil 21 and a secondary coil 22. The primary coil 21 has a coil end 211 connected with the first relay 1 and a center tap 212 for grounding through a resistor 30 and a capacitor 40. The common mode choke 3 could be a 2-wire common mode choke or a 3-wire common mode choke. The common mode choke 3 has a first side coil and a second side coil. The first side coil has two coil ends 31 connected to the secondary coil 22. The second side coil has a coil end 32 connected with the second relay 4.

The first and second relays 1, 4 control the transformers and common mode chokes to connect with two ports of a modular jack at different times, thus two ports of the modular jack transmit signals at different times and share only four transformers and four common mode chokes.

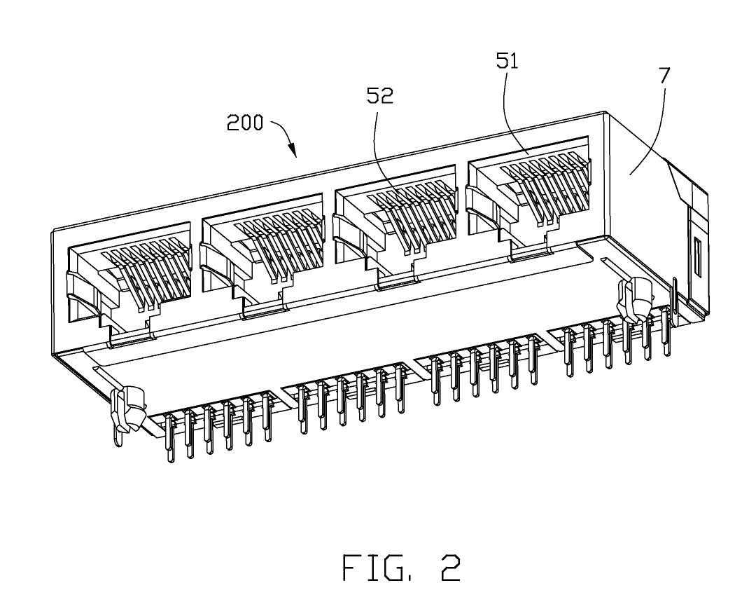

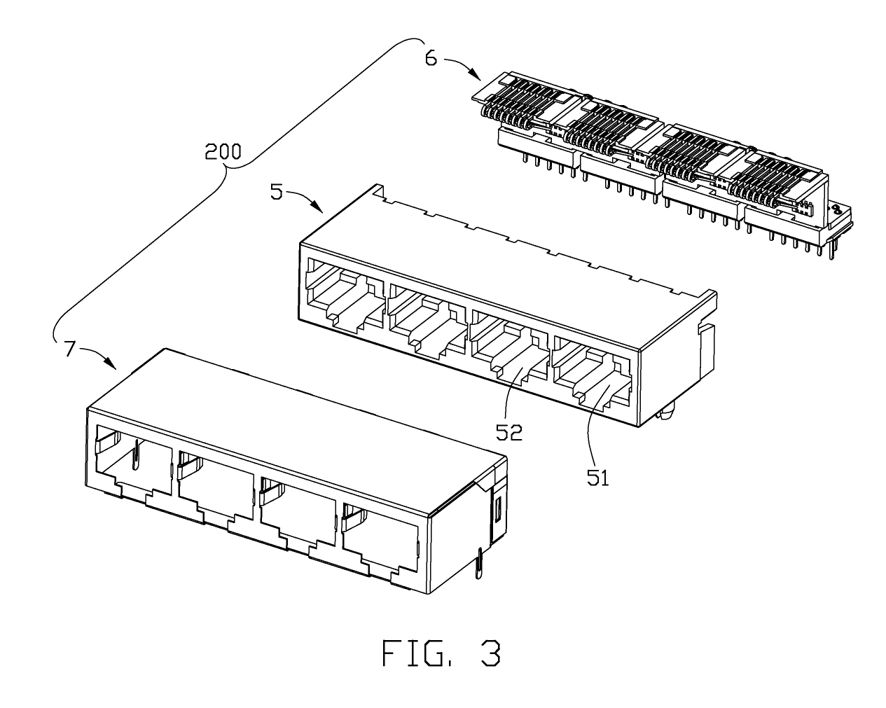

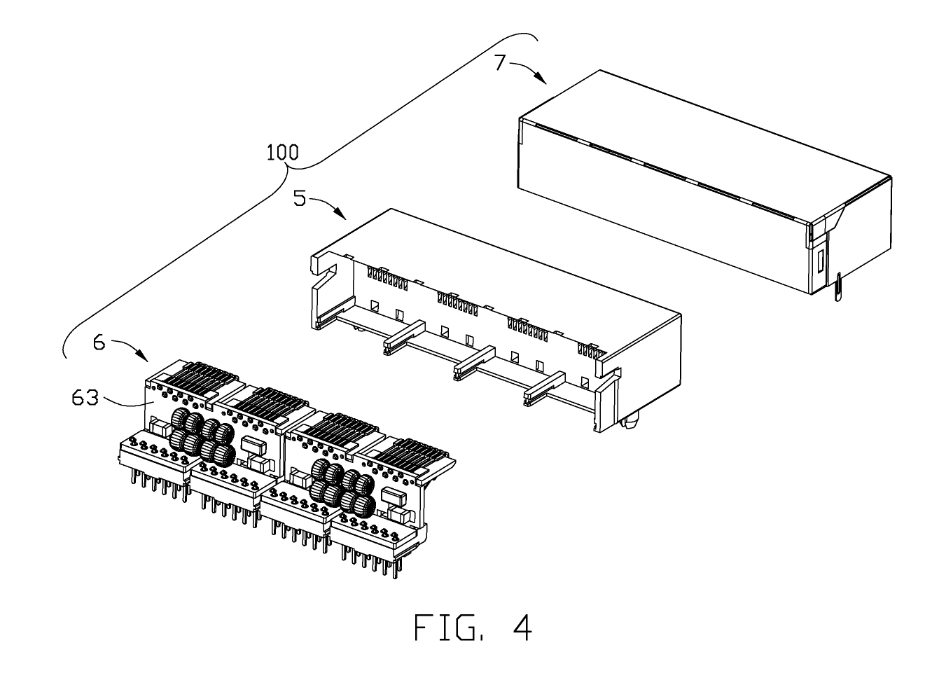

FIGS. 2-5 show a modular jack 200 using the modular jack circuit 100. The modular jack 200 includes an insulative housing 5, a contact module 6, and a shell 7 surrounding the insulative housing 5. The insulative housing 5 includes two receiving slots or ports 51, 52 for mating with plugs. Two ports 51, 52 include a first port 51 and a second port 52 share the contact module 6.

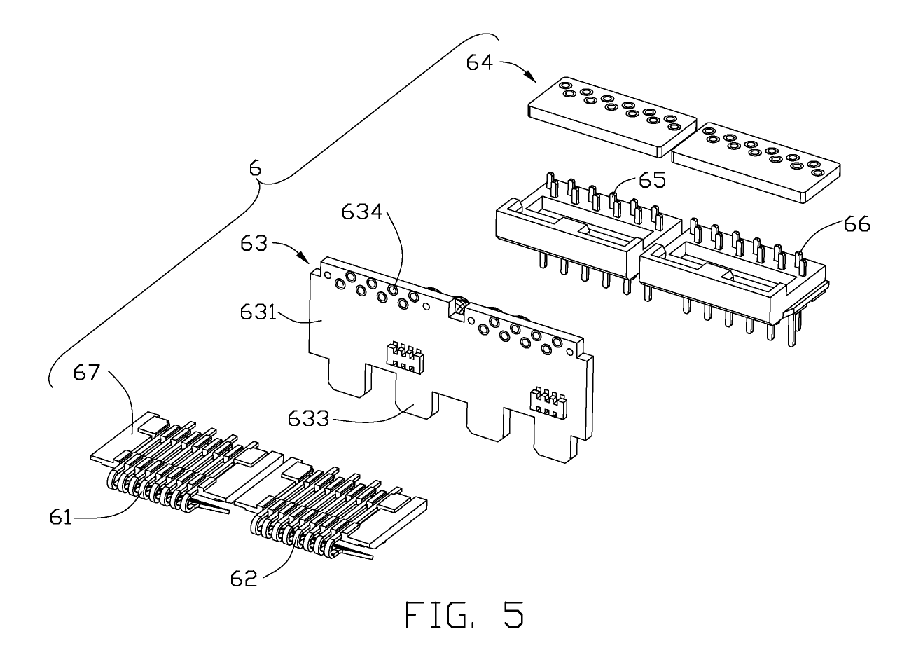

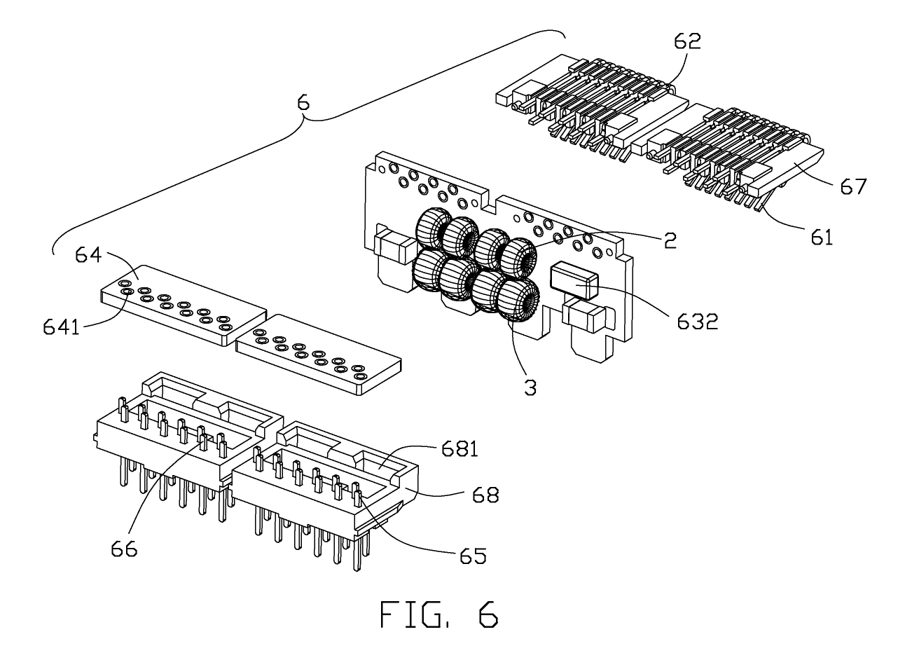

Referring to FIGS. 5-6, the contact module 6 includes a set of first mating contacts 61, a set of second mating contacts 62, a circuit board assembly 63, a second circuit board 64, a set of first mounting contacts 65, and a set of second mounting contacts 66. The first and second mating contacts 61, 62 are inserted into the first and second ports 51, 52, respectively. The circuit board assembly 63 filters electromagnetic noise. The circuit board assembly 63 includes a first circuit board 631, four transformers 2, four common mode chokes 3, and a relay assembly 632 disposed on the first circuit board 631. Certainly, the relay assmbly 632 also could be disposed as separated relays. The relay assembly 632 include eight first relays 1 and eight second relays 4 working as the circuit diagram shown in FIG. 1. The first and second mating contacts 61, 62 electrically connect to the first and second mating contacts 65, 66 through the relay assembly 632, the transformers 2 and the common mode chokes 3. The first mating contacts 61 and the second mating contacts 62 are respectively retained by two insulative bodies 67. The first circuit board 631 has a set of mounting holes 634 for the first and second mating contacts 61, 62 to insert therein and a set of protruding potions 633 extending downwardly. The second circuit board 64 has a set of mounting holes 641 for the first and second mounting contacts 65, 66 to insert therein. The first and second mounting contacts 65, 66 are respectively held by two insulative carriers 68 and connected with two second circuit boards 64. Each insulative carrier 68 has two mounting slots 681 for insertion of the protruding portions 633. The coil ends (not shown) of common mode chokes 3 physically and electrically connect with the first and second mounting contacts 65, 66. Alternatively, the relay assmbly 632 also maybe diposed on the mother board.

The first relay 1 could connect the first mating contacts 61 and the second mating contacts 62 at different times. Correspondingly, the second relay 2 could connect the first mounting contacts 65 and the second mounting contacts 66 at different times. Thus, the first port 51 and the second port 52 share only four transformers 2 and four common mode chokes 3. The first port 51 and the second port 52 transmit four differential pairs at different times through control of the first and second relays 1, 4 in a way know to those skilled in this art.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A modular jack comprising:
a housing including two receiving slots;
a circuit board carrying a plurality of filtering electronic elements;
a set of first mating contacts connecting to the circuit board and inserted into one of the two receiving slots;
a set of second mating contacts connecting to the circuit board and inserted into the other receiving slot;
a plurality of mounting contacts electrically connecting to the first and second mating contacts through the circuit board and the filtering electronic elements; and
a plurality of relays disposed on the circuit board and controlling the filtering electronic elements to transmit signals for the first mating contacts and for the second mating contacts at different times.

2. The modular jack as claimed in claim 1, wherein said filtering electronic elements include four transformers and four common mode chokes respectively connecting with the transformers through the circuit board, the transformers connecting to the mating contacts through the circuit board and the relays, the common mode chokes connecting to the mounting contacts through the circuit board and the relays.

3. The modular jack as claimed in claim 2, wherein said relays include a first relay disposed between each of said transformers and the mating contacts.

4. The modular jack as claimed in claim 2, wherein said relays include a second relay disposed between each of said common mode chokes and the mounting contacts, the first and second relays controlling the set of first and second mating contacts to transmit signals at different times.

5. The modular jack as claimed in claim 1, wherein the set of first mating contacts and the set of second mating contacts transmit four differential signal pairs through the first and second relays at different times.

6. A modular jack circuit between a cable side for connecting with a mating plug and a physical side for connecting with a mother board, comprising:
a first transmitting channel and a second transmitting channel;
a plurality of filtering electronic elements; and
a plurality of relays disposed between the filtering electronic elements and the cable side;
wherein the first and second transmitting channels share the filtering electronic elements, the relays controlling the first and second transmitting channels to transmit signals at different times.

7. The modular jack circuit as claimed in claim 6, wherein said filtering electronic elements includes a transformer and a common mode choke connecting with the transformer, the first and second channels sharing the transformer and the common mode choke.

8. The modular jack circuit as claimed in claim 6, futher including a plurality of relays disposed between the filtering electronic elements and the physical side.

9. The modular jack circuit as claimed in claim 6, wherein said filtering electronic elements includes four transformers and four common mode chokes connecting with the transformers, the relays controlling the transformers and the common mode chokes to transmit signals for two ports of a modular jack at different times.

10. A method of signal transmission via two ports, comprising steps of:
providing a printed circuit board with first and second transmission channels thereof, each of said first and second transmission channels including a set of input contacts and a set of output contacts;
provding only one set of filtering electronic elements mounted on the pritned circuit board and electrically connected to both said first and second transmission channels; and
providing first and second sets of relays on the printed circuit board respectively corresponding to said first and second transmission channels so as to control said first and second transmission channels to transmit signals at different times via the same set of filtering electronci elements.

11. The method as claimed in claim 10, wherien each set of the first set and the second set of relays includes corresponding relays connected to both the set of input contacts and the set of output contacts.

12. The method as claimed in claim 10, wherein the the set of input contacts are mounted to the printed circuit board while the set of output contacts are not.

13. The method as claimed in claim 10, wherein the filtering electronic elements are mounted to the printed circuit board.

14. The method as claimed in claim 10, further including a step of providing an insulative carrier to retain the printed circuit board.

15. The method as claimed in claim 14, wherein said insulative carrier further retain the set of output contacts of both first and second transmission channels.
